(19) United States
(12) Patent Application Publication
(10) Pub. No.: US 2026/0154577 A1
(43) Pub. Date: Jun. 4, 2026

(54) SHARED KNOWLEDGE GRAPHS

(71) Applicant: Medullar Solutions Inc., New York, NY (US)

(72) Inventor: Marc Llopart Riera, Terrassa (ES)

(21) Appl. No.: 19/402,140

(22) Filed: Nov. 26, 2025

Related U.S. Application Data
(60) Provisional application No. 63/726,699, filed on Dec. 2, 2024.
(60) Provisional application No. 63/794,791, filed on Apr. 25, 2025.

(51) Int. Cl. G06N 5/04; G06N 5/022

(52) U.S. Cl. CPC G06N 5/04; G06N 5/022

(57) ABSTRACT

Methods, systems, and apparatus, including computer programs encoded on computer storage media, for sharing knowledge graphs. One of the methods includes receiving a first identifier of a data source from a first client device and extracting a key phrase from the data source. The key phrase is added to a knowledge graph for a shared space. A second client device with access to the shared space submits a query to the shared space. A response to the query is generated using one or more key phrases from the knowledge graph for the shared space. The response is provided to the second client device.

### CROSS-REFERENCE TO RELATED APPLICATIONS

This application claims the benefit under 35 U.S.C. § 119(e) of U.S. Provisional Patent Application No. 63/726,699 filed on Dec. 2, 2024, and U.S. Provisional Patent Application No. 63/794,791 filed on Apr. 25, 2025, the entire contents of which are incorporated by reference herein.

### BACKGROUND

Searching for relevant results on electronic media can be time-consuming and frustrating as search engines may produce irrelevant results given the context of what is being searched for.

### SUMMARY

In general, one aspect of the subject matter described in this specification can be embodied in methods that include the actions of receiving, for a shared space and from a first client device associated with a first account, a first identifier of a data source. The method includes extracting a key phrase from the data source. The key phrase is added to a knowledge graph for the shared space. A query is received, through the shared space and from a second client device for a second account and that has access to the shared space. A response to the query is generated, using one or more key phrases from the knowledge graph for the shared space. The response represents associations between the one or more key phrases in the knowledge graph while not explicitly including at least some of the one or more key phrases used to generate the response. The response to the query is transmitted to the second client device.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Extracting the key phrase may use at least one of a large language model, natural language processing, or retrieval augmented generation. After the key phrase is extracted from the data source, the method or system may determine whether an extraction threshold is satisfied for the data source. In response to determining that the extraction threshold is satisfied for the data source, any local data for the data source may be deleted. An embedding of the key phrase and a second identifier may be generated and stored in a vector database. Storing the embedding in the vector database can include encrypting the embedding and storing the encrypted embedding in the vector database. The first identifier can include metadata of the data source and adding the key phrase to the knowledge graph for the shared space can include updating the key phrase by appending the metadata to the key phrase and storing the updated key phrase in the knowledge graph of the shared space. Adding the key phrase to the knowledge graph for the shared space may include adding the key phrase and the second identifier of the data source to the knowledge graph. Generating the response may include determining, using the second identifier of the data source, a permission for a second account to access the data source and using the permission for the second account to access the data source. The method may further include receiving a request from a third computer for a third account to delete data for a data source and deleting from the knowledge graph the data using identifiers in the knowledge graph. Receiving, for the shared space, the first identifier of the data source may include capturing, by a browser extension on the first client device, query data associated with the query and that was provided as input to another system, determining, by the browser extension, to associate the query data with the data source that has the first identifier, and in response to determining to associate the query data with the data source that has the first identifier, transmitting, by the browser extension, the first identifier of the data source. The shared space may include two or more shared spaces. Adding the key phrase to the knowledge graph for the shared space can include selecting, by the first client device and from the two or more shared spaces, a shared space and adding the key phrase to the knowledge graph of the selected shared space of the one or more shared spaces. Selecting the shared space from the one or more shared spaces may include ranking each of the two or more shared spaces using a criterion and selecting the shared space from the two or more shared spaces using the ranking of the two or more shared spaces. Ranking each of the two or more shared spaces can use the criterion that includes at least one of a similarity calculation between keywords of each of the one or more shared spaces and the first identifier, a recency of accessing each of the one or more shared spaces by the first account, or a number of accounts accessing each of the one or more shared spaces.

The subject matter described in this specification can be implemented in various implementations and may result in one or more of the following advantages. In some implementations, the systems and methods described in this specification can increase data security, data privacy, or both, e.g., by generating query responses using key phrases from a knowledge graph for a shared space. In some implementations, the systems and methods described in this specification can be more accurate than in other systems, e.g., have reduced or no hallucinations, by generating results using data from a knowledge graph that was added based on files provided to the corresponding shared space. By sharing information from the knowledge graph, privacy can be increased, e.g., preserved, since the shared information is not the actual content of a particular document.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an environment in which a knowledge graph is produced.

FIG. 2 illustrates some details of the system of FIG. 1.

FIG. 3 illustrates additional details of the system of FIG. 1.

FIG. 4 illustrates a flow chart of an example operation of the system of FIG. 1.

FIG. 5 illustrates an example implementation of the system of FIG. 1.

FIG. 6 illustrates an example implementation of an environment including a web browser extension.

FIG. 7 illustrates an example of the browser extension adding an entire web page to the space.

FIG. 8 illustrates an example of the browser extension adding selected images to the space.

FIG. 9 is a block diagram of a computing system that can be used in connection with computer-implemented methods described in this specification.

Like reference numbers and designations in the various drawings indicate like elements.

### DETAILED DESCRIPTION

The system can enable improved responses to queries by building and maintaining a knowledge graph based on documents, files, and other information. The system can generate the knowledge graph by extracting a key phrase from the data sources and adding the key phrase to the knowledge graph, along with information about the data source. When the system receives a query, it accesses the knowledge graph to help provide a response to the query. The knowledge graph helps to identify the most relevant information to which the system has access.

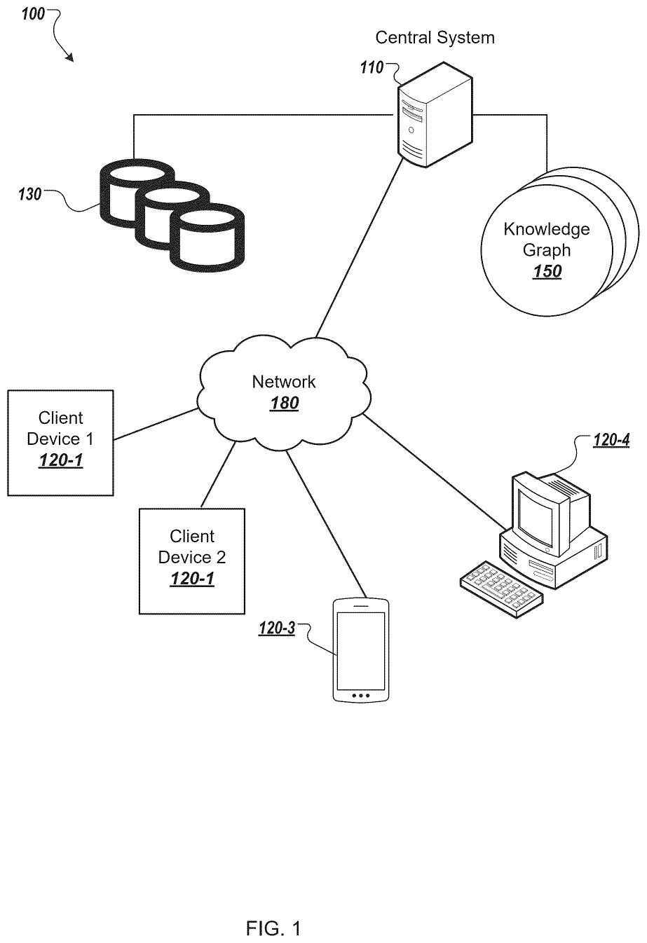

FIG. 1 illustrates an example environment 100 in which a knowledge graph is produced to respond to queries while maintaining the privacy of the underlying source documents or files. The environment 100 can be used for generating a response to a query. The environment 100 includes a central system 110, a client device 120, a database (DB) 130, a knowledge graph 150, and a network 180 connecting all these elements. The client device 120 may include multiple client devices, for example a first client device 120-1, a second client device 120-2, etc. The client devices 120 may include a desktop computer (e.g., desktop computer 120-4) a smartphone (e.g., smartphone 120-3), and the like. The database 130 may be a vector database. The central system 110 can generate and maintain a knowledge graph 150. The knowledge graph 150 is associated with an account on a client device 120. The knowledge graph 150 may be stored separately from the database 130 or may be stored as part of the database 130. The knowledge graph 150 may be stored as part of a vector database 130.

The central system 110 is an example of a system implemented as computer programs on one or more computers in one or more locations, in which the systems, components, and techniques described in this specification are implemented. The client devices 120 can include personal computers, mobile communication devices, and other devices that can send and receive data over a network 180. The network, such as a local area network (“LAN”), wide area network (“WAN”), the Internet, or a combination thereof, connects the client devices 120 with the central system 110. The central system 110 can use a single computer or multiple computers operating in conjunction with one another, including, for example, a set of remote computers deployed as a cloud computing service.

The central system 110 can include several different functional components, including one or more shared spaces (described in more detail below), an AI model (described in more detail below), a processor (e.g., a central processing unit, a graphics processing unit, etc.) and storage. Any one or more of the components can include one or more data processing apparatuses, can be implemented in code, or a combination of both. For instance, each of the components can include one or more data processors and instructions that cause the one or more data processors to perform the operations discussed in this specification.

The various functional components of the central system 110 can be installed on one or more computers as separate functional components or as different modules of a same functional component. For example, the processors of the central system 110 can be implemented as computer programs installed on one or more computers in one or more locations that are coupled to each through a network 180. In cloud-based systems for example, these components can be implemented by individual computing nodes of a distributed computing system.

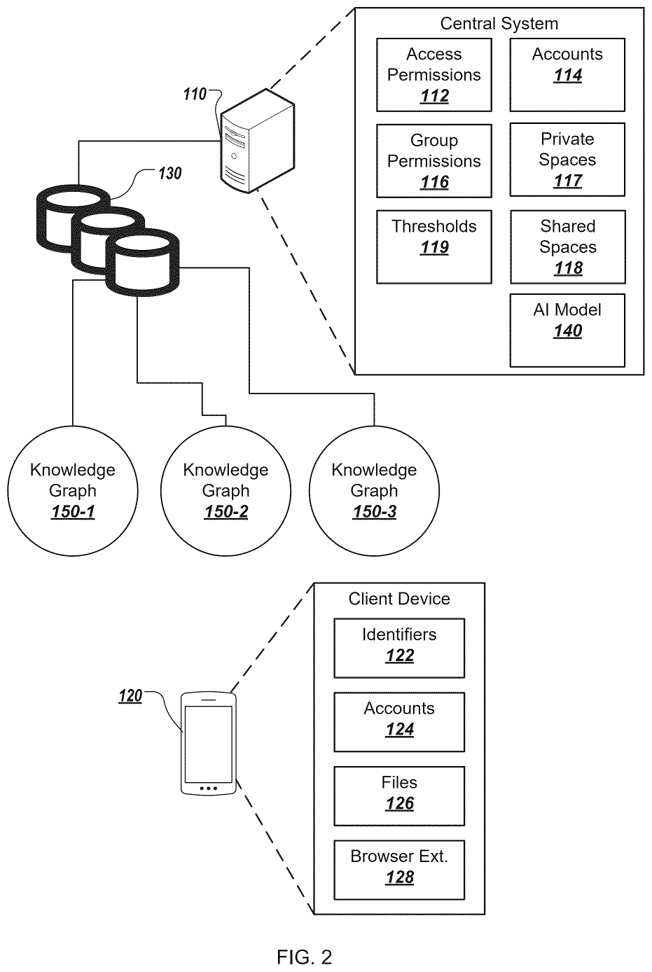

FIG. 2 illustrates some details of the environment 100 of FIG. 1. The central system 110 may include, e.g., in memory, access permissions 112, accounts 114, group permissions 116, private spaces 117, shared spaces 118, thresholds 119, and an AI model 140. The central system 110 has access to the database 130. In the example depicted in FIG. 2, the knowledge graphs 150 (e.g., first knowledge graph 150-1, second knowledge graph 150-2, third knowledge graph 150-3, etc.) are stored on the database 130, but the system is not limited to such a particular configuration.

The central system 110 maintains accounts 114 associated with individual users. Each account can have associated with it one or more shared spaces 118 or private spaces 117 for sharing data from data sources, e.g., information, data, files, etc., with other accounts or for storing data for access by a single account. The shared space 118 includes files, documents, data, and the like along with access permissions 112 associated with each file or document. In some instances, the shared space 118 can have a corresponding knowledge graph 150 that represents some of the corresponding data, e.g., documents or other types of files, without including the actual data for those sources. Some shared spaces 118 may have group permissions 116 which indicate what associated accounts have access to the corresponding shared space. Some shared spaces 118 may have access permissions 112 that indicate which accounts have access to which data sources. Thus, by using the access permissions 112 and the group permissions 116, the central system 110 can permit certain groups of accounts to perform certain actions in the corresponding shared space. Examples referring to a shared space 118 can apply to a private space 117, potentially with appropriate changes (e.g., authentication requirement(s), encryption for stored information, different permissions, or combinations of these). The private space 117 can have different permissions than the shared space 118. In some implementations, either a shared space 118 or a private space 117 can have its data encrypted, require authentication to access it, or both. Examples referring to a private space 117 can apply to a shared space 118. In some implementations, a private space 117 can be associated with a single account and a shared space can be associated with one or more accounts. An account 114 can be associated with multiple spaces. A client device 120 can be associated with multiple spaces.

The central system 110 determines allocations of shared spaces 118, e.g., where data for a shared space is stored. The shared spaces 118 include electronic or magnetic storage media for storing data and files. In some implementations, the central system 110 integrates the knowledge graph 150 and the vector database 130 into a single platform. In some implementations, the vector database 130 and the knowledge graph(s) 150 are stored separately. In some implementations, both the vector database 130 and the knowledge graph 150 are hosted on the same server and use the same storage infrastructure. Hosting on distinct servers may enhance scalability, reliability, and performance of the central system 110.

In some examples, the central system 110 may have thresholds 119, which are threshold values for performing certain operations. One example threshold 119 may be in evaluating a query to determine if an account from which the query was received requires access to the knowledge graph 150, or a particular knowledge graph, to receive data responsive to the query. If the query is relatively simple as determined by the threshold (e.g., what is the current time in Paris, France?), the system may answer without access to the knowledge graph 150. If the query is not relatively simple, e.g., as determined by the threshold, or relates to a particular account (e.g., who are the best three sales reps in California?), then access to the knowledge graph may significantly improve an accuracy, quality, or both, of the response.

The client device 120 may include an identifier 122, an account 124, a file or files 126, a browser extension 128, or any combination of these. The identifier 122 may be an identifier of the individual client device 120, such as a MAC address, a unique identity number, an IP address, etc., or the identifier 122 may be associated with an individual account 124 and the client device 120, or both. In instances with a single client device 120 having multiple accounts 124 associated with it, having an identifier specific to the device 120 and to the account 124 might be needed to distinguish the multiple accounts each of which can be associated with a different corresponding user. The client device 120 may have files 126 stored locally (e.g., a spreadsheet) or files 126 stored remotely or some mixture (e.g., emails) of files stored locally and remotely.

The browser extension 128 can collect text, video, images, files, or any combination of these, from a webpage or multiple webpages in a website while the client device accesses the webpage or website through a web browser or another appropriate application. In some implementations, the browser extension 128 provides an interface on the client device 120 by for the selection and storage of digital content. Example digital content includes search results, metadata such as source URLs, timestamps, and contextual information, or any combination of these. The digital content can support later retrieval and classification.

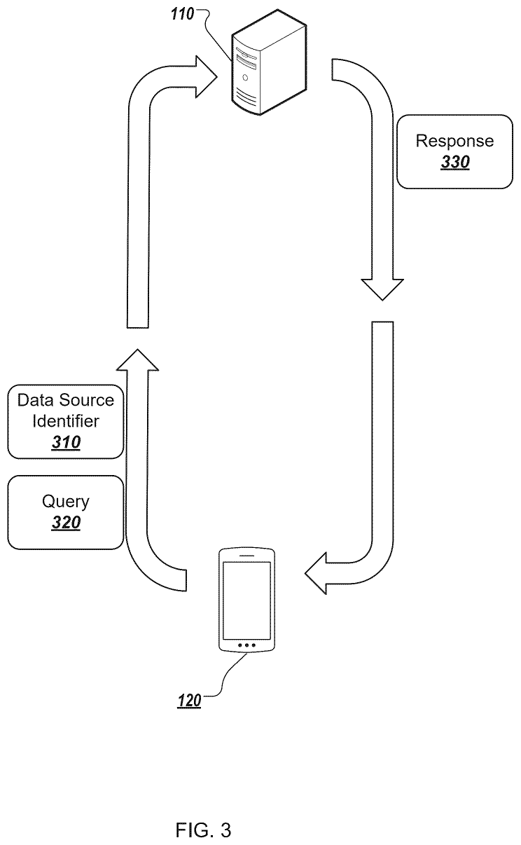

FIG. 3 illustrates additional details of the environment 100 of FIG. 1. When the client device 120 submits data to the central system 110 for inclusion in a shared space 118, the submission includes a data source identifier 310 and the identifier 122 for the account 124. The central system 110 can then add data from the data source, e.g., add key phrases, to the knowledge graph for the corresponding shared space 118. In implementations in which the shared space 118 has different knowledge graphs for different accounts that have access to the shared space 118, the central system 110 can use the identifier 122 to determine the corresponding knowledge graph 150 to which the data from the data source should be added.

The central system can receive a query 320 for data that is specific to a shared space, e.g., to which the corresponding client device 120 has access. The central system 110 provides a response 330 to the query 320 using data from one or more knowledge graphs for the shared space. As is explained elsewhere in this specification, the central system 110 identifies the relevant data or files and generates a response 330.

The central system 110 may receive for a shared space 118 and from a first client device 120-1 associated with a first account 124, a first identifier of a data source 310. The central system 110 extracts a key phrase from the data source and adds the key phrase to a knowledge graph 150 for the shared space 118. When extracting the key phrase, the central system 110 may use at least one of a large language model, natural language processing, or retrieval augmented generation.

The central system 110 may receive through the shared space 118 and from a second client device 120-2 for a second account 114 and that has access to the shared space 118, a query 320. The central system 110 may generate a response 330 to the query 320 using one or more key phrases from the knowledge graph 150 for the shared space 118. The response 330 represents associations between the one or more key phrases in the knowledge graph 150 while not explicitly including at least some of the one or more key phrases used to generate the response 330, the data used to generate the one or more key phrases, or both. For instance, since the knowledge graph 150 does not include the underlying data used to generate the one or more key phrases, the central system 110 might only be able to generate responses using the one or more key phrases without using that underlying data. The central system 110 may transmit the response 330 to the query 320 to the second client device 120-2.

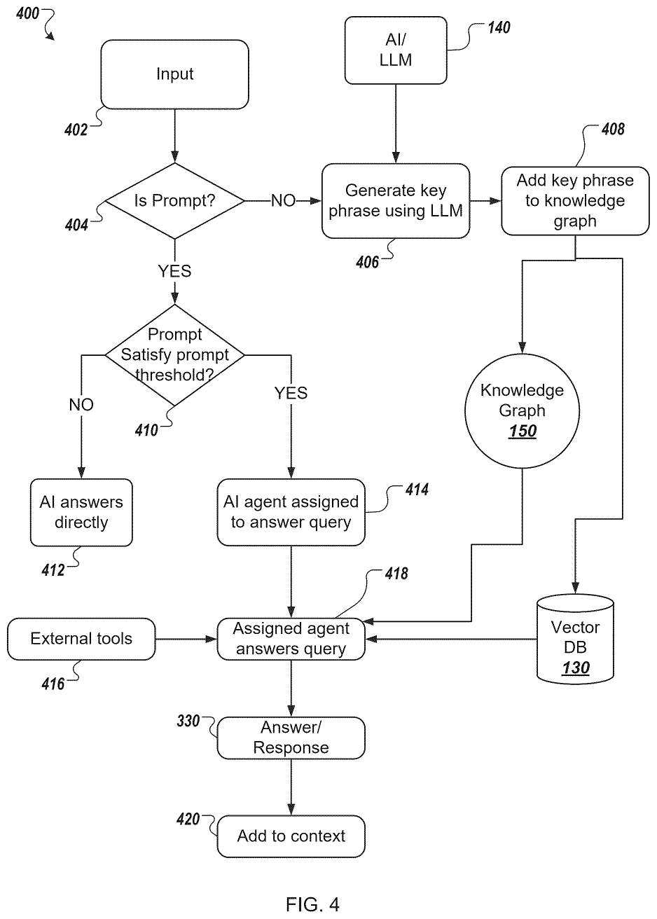

FIG. 4 illustrates a flow chart of an example process of the system of FIG. 1. The central system 110 receives an input 402 from a client device 120. The input 402 includes the query 320, a data source identifier 310, the account identifier 124 for accessing the account 114 of the central system 110, or any combination of these. The central system 110 evaluates whether the input 402 is a prompt 404. If the input is not a prompt, then the central system 110 generates a key phrase using, for example, a large language model (LLM) or an artificial intelligence system (AI) 140. This can occur when the input 402 includes the data source identifier 310 and the account identifier 124 and is part of a request to add data to a corresponding shared spaced, e.g., identified in the input 402. The central system 110 adds the key phrase to the knowledge graph 150 and to the vector database 130 at operation 408. The knowledge graph can be a general knowledge graph for the shared space, or a knowledge graph specific to the account. In some instances, the shared space can include data indicating the types of knowledge graphs used for the shared space. In some examples, the input 402 can include data that indicates the knowledge graph type, the particular knowledge graph, or both, to which the data should be added.

If the input 402 is determined to be a prompt at operation 404, the system evaluates whether the prompt satisfies a prompt threshold at operation 410. If the prompt fails to satisfy the prompt threshold, the central system 110 responds by answering the query directly. For example, if the query is simple and requires little context (e.g., “is it snowing in Denver, CO right now?” or “what is the distance between Philadelphia and New Orleans?”) the central system 110 may provide a response directly without needing to access the knowledge graph.

If the prompt satisfies the prompt threshold, then the central system 110 can respond to the query using data from a knowledge graph. For instance, the central system 110 can assign an AI agent to respond to the query at operation 414. The assigned agent may request results from external tools 416, from the vector database 130 or the knowledge graph 150, or any combination of these. An example of an external tool 416 is a search engine with access to the internet or local storage on a client device, e.g., the client device from which the central system 110 received the input 110 or another client device. The external tools are therefore external to the central system 110 but not necessarily external to the client device 120 itself.

At operation 418, the agent integrates the results provided from one or more of the external tools 416, the knowledge graph 150, or the vector database 130 to generate the response 330 to the query 320. The central system 110 provides a response 330 to the client device 120. The central system 110 may add context 420 to the response. The context 420 may be determined by the knowledge graph 150.

In some implementations, the central system 110 may determine whether an extraction threshold is satisfied for the data source after extracting the key phrase from the data source. In response to determining that the extraction threshold is satisfied for the data source, the central system 110 may delete any local data for the data source. The extraction threshold can represent whether the central system 110 has likely extracted all relevant key phrases from the corresponding data source. In response to determining that the extraction threshold is not satisfied, the central system 110 can continue to extract additional key phrases from the data source for inclusion in the corresponding knowledge graph.

In some implementations, the central system 110 may generate an embedding of the key phrase and a second identifier and store the embedding in a vector database 130. The central system 110 may add the key phrase and the second identifier to the knowledge graph 150. The embedding can be any appropriate type of embedding, e.g., for the vector database 130. The second identifier can be an identifier for the data source.

When the central system 110 receives a query for data from the shared space, the central system 110 may generate the response 330 by determining, using the second identifier of the data source, a permission for a second account to access the data source and generate the response using the permission for the second account to access the data source.

In some implementations, the central system 110 may receive a request from a third computer for a third account to delete data for a data source. The central system 110 may delete the data from the knowledge graph 150 using identifiers in the knowledge graph 150. For instance, when the central system 110 maintains a knowledge graph for each account, the central system 110 can use the identifier for the data source to delete all data in the knowledge graph that is only associated with that data source. In some instances, data in the knowledge graph might have multiple sources. In these instances, the central system 110 can remove the identifier for the data source for that corresponding key phrase or other data in the knowledge graph without removing the key phrase itself. The key phrase would then still be associated with other data source identifiers.

When the central system 110 maintains one knowledge graph for a shared space for data from multiple accounts, the central system can use the account identifier and the data source identifier to determine the data to delete from the knowledge graph. If any particular data is associated with multiple accounts, multiple data sources, or both, the central system can remove the account and data source identifiers from that data while leaving the data, e.g., key phrases, associated with the other account and data source identifiers.

A client device can store information in a vector DB 130 but can choose to add only certain documents or files. The client device might share only certain files with other accounts or devices, for example when a patient does not care to share her eye-related medical records with her dentist because she feels it is not relevant to the dentist's ability to diagnose her problems with her teeth.

A client device can share many files by placing them in a shared space 118 which has access to a database 130, for example, a vector database. When the client device shares files, the client device can store the files in the database 130 and define permissions associated with the files and with the accounts 114, 124 of the client devices which have been granted access to the files. As part of adding the files to the shared space(s) 118, the central system 110 receives the file (e.g., text file, audio file, image file, video file, etc.) and processes these files to create embeddings. For example, each file can be processed to create an embedding associated with that file. The vector database 130 stores these embeddings and permits fast and easy comparison of the similarity between the embeddings. When a query 320 is submitted to the central system 110 with access to the vector database 130, the knowledge graph 150, and the shared spaces 118, the central system 110 generates a response taking into account all these sources of information. When a client device adds a new file to a shared space 118, an embedding of the new file is generated and stored in the vector database 130 for the corresponding knowledge graph 150.

When a client device on an account 114, 124 submits a query 320 to the shared space 118, the query 320 may include additional information, such as the access permissions 112 and the group permissions 116 associated with the account 114, an identifier 122 of the client device 120 or of an account 124 on the client device 120. The central system 110 accesses the knowledge graph 150 associated with the account 114 to provide context for the search. The context can include any appropriate data. For instance, when the shared space includes a chat feature, the context can include data from that chat feature. In these instances, the central system 110 can receive the input 402 by way of the chat feature, e.g., through a chat user interface control. The central system 110 searches the shared space 118, taking into account the knowledge graph 150 and the context in order to provide a response 330. In some instances, the central system can include some context 420 with the response 330. As part of retrieving the relevant information from the shared space 118, the central system 110 can include, for example, retrieval augmented generation (RAG), AI agents, and similar methods.

When the central system 110 generates the response, it may access multiple different sources of information. In some implementations, the central system 110 may access external tools 416 and the internet to generate the response 330. In some implementations, the central system 110 may perform a search of the local client device 120 or perform a limited search of the shared spaces 118 associated with the accounts 114, 124 or which the account 114, 124 has permissions to access. In some implementations, the central system 110 accesses the knowledge graph 150 to provide context or determine the most relevant or most significant sources of data for a particular query 320. The central system 110 can determine the most relevant sources, the most significant sources, or both, using corresponding criteria, such as the thresholds 119. In some implementations, the central system 110 accesses the vector database 130 to perform, for example, a nearest neighbor search of the query with the embeddings stored in the database 130. The central system 110 can consolidate all these results to produce the response.

In some examples, the search performed by the central system 110 may be a federated search using multiple tools and multiple sources. The federated search may produce results which are consolidated and the consolidated results are added to the shared space 118. From these results, a summary can be extracted, the data sources identified, and key phrases relevant to the extracted result content may be generated using a large language model. The key phrases generated by the large language model may be added to the knowledge graph 150 to enhance its ability to provide context for future queries. When this account performs future queries, the central system 110 may initially access the knowledge graph 150 to see whether the account is associated with certain key phrases in the past or whether query results for the account included key phrases from past searches. These key phrases can provide context for a current search query. Once the key phrases have been added to the knowledge graph 150 and the extracted result content has been added to the shared space 118 on the vector database 130, the actual files used for the extraction may be removed.

In some example implementations, a client device associated with an account 124 may browse the web and one or more websites the client device visits or browses may be scraped for information, e.g., depending on the settings of the website, the account, or both. The client device associated with an account 124 may select certain of this content to be added to an associated shared space 118. By adding the content to the shared space 118, data are extracted and key phrases are generated and added to the knowledge graph 150. The key phrases and an embedding are added to the vector database 130 hosting the shared space 118.

In some implementations, the scraping for information is performed by the browser extension 128. The browser extension 128 may select a space from amongst multiple spaces for adding the information from the websites. The selection of the space may include ranking each of the one or more spaces for inclusion of the information. In some implementations, the selection of the space may include a similarity calculation between key phrases of the space and the information of the website. In some implementations, the selection of the space may include a determination a how recently in time the space was accessed by the account, or how recently in time the space was accessed by the client device or how recently in time the space was accessed by any account associated with the space. In some implementations, the selection of the space may include how many accounts or client devices accessed the space within a certain period of time. These selection ranking criteria are examples, and implementations are not limited thereto.

In some examples, the client device associated with an account 124 may access files stored on the local system and add these files to the shared space 118. Client device may browse a file system of an individual computer or of a series of computers. The client device may drag and drop files into the shared space 118. From these files, results are extracted, key phrases are generated, the knowledge graph 150 is built up and the vector database is improved or extended, and then the files are deleted.

In some implementations, several accounts 124 associated with several client devices 120 may interact with each other and with the central system 110. Such interactions may constitute chatting with each other, chatting with an AI agent of some sort, or both. The chat interactions can be submitted to the AI to generate key phrases using, for example, a large language model 140. The key phrases may be added to the personal knowledge graph 150.

In some example implementations, a shared space can have a knowledge graph for a corresponding account. When the account is for a patient, the knowledge graph can include corresponding patient healthcare information. In these implementations, the patient might not want all doctors or other care providers to have access to all of the patient's healthcare information. For example, the user's personal care physician may have full access to the entire health database including all of the patient's records while another care provider might only need access to a portion of the healthcare information. The primary care physician may be able to edit, add to, correct, and update the user's healthcare records, e.g., given corresponding group permissions. The central system can limit access to only the primary care physician, or to only the primary care physicians'immediate colleagues in the same practice location. When a physician device requests healthcare information about the patient, e.g., using a shared space, the central system can determine group permissions for the corresponding account. The central system can use the group permissions to determine the types of data to which the physician's account should be granted access. For example, the user's healthcare knowledge graph 150 may include the key phrase “sunburn” with data source identifiers of other records when the patient has gotten sunburned several summers in a row. When the query is for information about a sunburn and the physician's account does not have full access to the shared space, the central system can generate a response that includes information about the instances when the patent has gotten sunburned, e.g., in several summers in a row. Thus, the response may enable the physician to provide better advice to the patient given that the patient is likely to be exposed to too much sunlight in the coming summer without having access to private medical information that the patient has not shared with them.

In some examples, an executive at a large company may want to know about sales in a certain division or in a certain region over the past several years. The executive may use their client device to submit a query to a corresponding shared space that includes one or more knowledge graphs. A knowledge graph 150 for the executive's account might indicate that the executive mostly deals with a particular product line. The central system 110, e.g., a query processing engine implemented on the central system, can use the query and the executive account's knowledge graph to generate results that include the sales of that particular product line and only secondarily the comparative sales of other products in the same region of the same division. In some instances, the results can include sales of all products lines but only provide the executive's account with detailed information about the sales of the particular product line while preventing access to detailed information about the sales of the other product lines. This can occur because the executive account's knowledge graph includes data, e.g., key phrases, for the detailed information about the sales of the particular product line and corresponding access permissions for that knowledge graph indicate that the executive account has full access to that data. The central system can use one or more other knowledge graphs to generate the sales information for the other product lines. The central system can determine, given the access permissions for the other knowledge graphs, to skip inclusion of the detailed information for the other knowledge graphs in the response, e.g., because access permissions indicate that the executive account does not have access to those other knowledge graphs.

In some examples, a physician may be treating the patient while the patient is visiting her grandchild on vacation. The patient does not wish the new physician to have full access to her medical records. The patient's client device can grant the physician's account access to a shared space for which the patient's knowledge graph was generated using the patient's medical records. The physician's device may request certain information and be provided, for example, a summary of the patient's medical history, that does not include particular details that patient does not wish to share, that are not part of the knowledge graph, or both. For instance, the knowledge graph might only have key phrases from the patient's medical history which can reduce a likelihood that the physician's account gains access to data from the underlying medical records, e.g., which data the physician might not need.

In some implementations the central system may identify particular accounts 124 as being associated with experts in certain areas. The experts may be identified based on the key phrases added to their personal knowledge graph 150. The central system can generate recommendations for granting an expert's account access to a shared group, e.g., for which the central system determines that the expert's knowledge satisfies an assistance criterion as potentially beneficial for the shared group.

The central system can be provided with files and records and the central system indexes these records so that they are readily available for a search. A client device creates a shared space 118 (e.g., a personal shared space 118). In a personal shared space 118, the client device must determine which records are available to share with devices or with other accounts. The client device specifies which other accounts 124 have permission to access the files, read the files, modify the files, or delete the files. These permissions determine the level of privacy and enforce that privacy. Different files can be added to the shared space 118, for example the results of a federated search, files on the local computer, or files from other websites such as GitHub. Adding content or a document to the shared space 118 means that the content or document is processed and an encoding or embedding of the content is created and stored in the vector database 130. The actual content or the actual record is not necessarily stored. If other client devices add to the shared space 118, the shared space 118 may become more useful.

As part of a query, a first user can request certain information (e.g., a spreadsheet showing sales the last three years in a particular division of the company). A second user may have previously provided at least some of the requested information on the shared space 118 (e.g., a spreadsheet detailing all the sales of all the divisions of the company worldwide). When the first user requests the information, they may be provided with only the information requested but not the details of the entire spreadsheet which would be hidden from them.

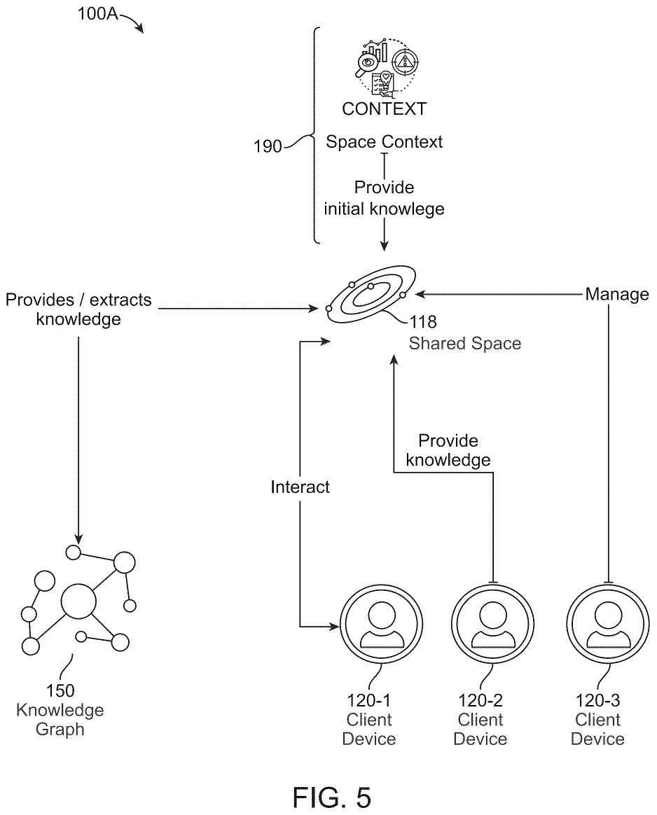

FIG. 5 illustrates an example implementation of the environment of FIG. 1. The example environment 100A has three client devices 120-1, 120-2, and 120-3 interacting with a shared space 118, but any number of client devices may be used. The first client device 120-1 interacts with the shared space 118 and may both provide data or information and request information from the shared space 118. In the example illustrated, the second client device 120-2 provides information to the shared space 118 but does not request information from the shared space. In the example illustrated, the third client device 120-3 manages the shared space 118. Managing the shared space 118 may include functions such as administration, permitting new client devices or accounts to access the shared space 118, deleting expired client devices or accounts from accessing the shared space, and the like. The knowledge graph 150 provides information to the shared space 118. In the example illustrated, the shared space 118 is provided with initial information, knowledge, and context 190 when the shared space 118 is initially set up. Such initial knowledge 190 may be provided by, for example, the managing client device 120-3, or by the client device 120 which initially sets up the shared space 118. Multiple shared spaces 118 can be created, each with its own associated knowledge graph 150 or knowledge graphs, e.g., per account, which knowledge graph(s) are not shared between spaces.

In some embodiments, the shared spaces 118 may include a hierarchical organization of knowledge spaces. For example, a first space can be designated as a parent space and one or more other spaces can be designated as child spaces of the parent space. The parent space includes a set of knowledge objects (e.g., distilled key phrases, identifiers, documents, links, and associated metadata) collectively referred to as parent knowledge. Each child space is configured to inherit at least some of, e.g., the entirety of, the parent knowledge objects, while maintaining its own unique knowledge objects (child knowledge). Whenever a change occurs in the parent knowledge—through addition, modification, or deletion of one or more knowledge objects—the changes can be automatically propagated to one or more, e.g., all, associated child spaces, e.g., in near real-time or upon synchronization.

For instance, a child space can include a current replica of the knowledge objects to which its parent space gives it permission to access (inclusive of ongoing parent updates) and its own distinct set of knowledge objects that can be exclusive to the child space. Edits performed within a child space might not propagate upward to the parent space, laterally to sibling spaces, or both. In some instances, only downward propagation (from parent to child or from child to grandchild) might be permitted. This structure can increase a likelihood of controlled inheritance of knowledge, reduce a likelihood of unintended overwriting or merging of independent data sources, or both. In some implementations, synchronization between the parent and child spaces may be event-driven, scheduled, triggered upon modification thresholds, or any combination of these, e.g., at different times. The propagation mechanism may utilize vector embeddings, graph-based versioning, or both, to increase a likelihood of consistency between the inherited and local knowledge objects for a knowledge space. In some examples, the head of a network security team may have a parent space and each of the regional network security techs has a child space of the head's parent space. The head of network security may share certain knowledge objects with each of the knowledge spaces of the regional network security techs, such as corporate IT policies, local security related documents, recent attempts to hack into corporate servers, newly identified malicious actors, new network vulnerabilities, and the like, while retaining certain information to the head office network security space, which may not be shared with the child spaces, such as, for example, draft changes to corporate network security policies or and results of internal security probes conducted at the headquarters building, or other knowledge objects to which the regional techs should not have access.

In some embodiments, the system provides functionality for cloning an existing knowledge space. A cloned space is an independent instantiation created from an existing progenitor space, for which all knowledge objects and associated metadata can be duplicated at a specific point in time. Upon cloning, the newly created cloned space receives an initial copy of at least a subset of, e.g., all, knowledge objects and metadata of the progenitor space. The subset can be identified via input received during the cloning process. After completion of the cloning operation, the two spaces become independent and non-synchronized. Subsequent modifications, additions, or deletions made in either the progenitor space or the cloned space may not be propagated between them. In some examples, further synchronization or inheritance may not occur after cloning.

In some embodiments, the cloning operation may preserve access permissions, identifiers, version history metadata, or any combination of these, of the progenitor space, e.g., depending on cloning configuration. Optionally, cloned spaces may be re-linked with the progenitor space to form a new parent-child relationship after the cloning operation has been completed. In some examples, a cloned space can be used for after-the-fact analysis of a viral infection, to determine if protecting software has properly removed the virus from the knowledge space, or both.

The hierarchical and cloning functionalities described in this specification can enable flexible organizational modeling, controlled propagation of knowledge across distributed environments, or both. Example applications can include enterprise knowledge hierarchies, sandbox or testing environments, and contextual access control. In some embodiments, central parent spaces maintain standardized policies, procedures, or training data and can propagate updates to departmental or regional child spaces. Departments may extend local knowledge bases while inheriting global updates automatically. In some embodiments, cloned spaces allow experimentation, testing, or customization of knowledge without affecting the progenitor space such as production or regulated datasets. Cloned spaces may serve as temporary branches for isolated processing or research purposes. Parent-child inheritance can respect existing access permissions, increasing a likelihood that inherited knowledge remains subject to the privacy, encryption, and permission controls defined in the base specification of the shared knowledge graph system.

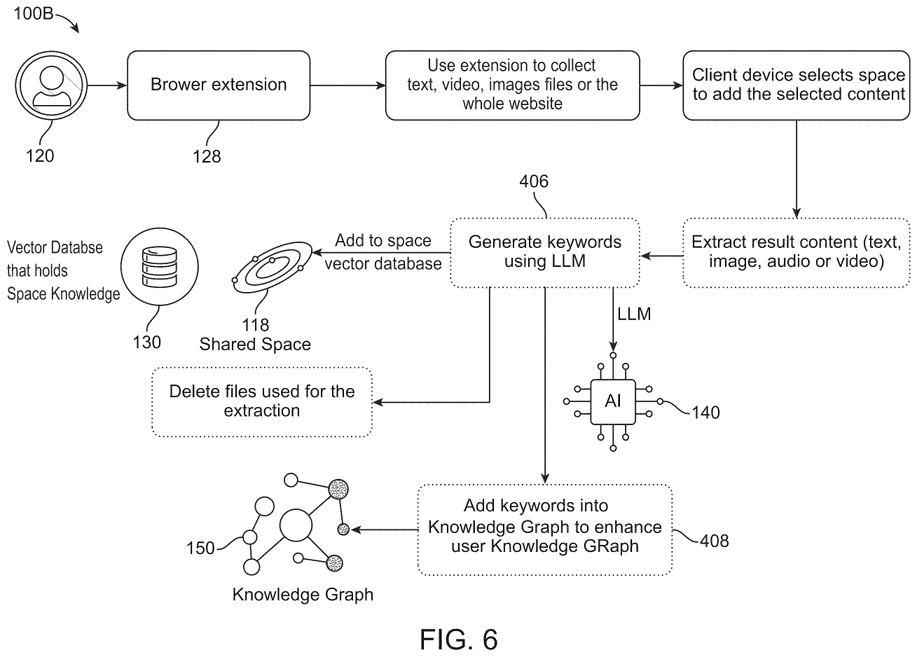

FIG. 6 illustrates an example implementation of an environment including a web browser extension. An environment 100B includes a client device 120 with a web browser extension 128. As the client device 120 accesses digital content using the web browser, the browser extension 128 collects digital content. For example, the browser extension 128 can collect text, video, images, files, an entire website, or any combination of these. The client device 120 can select which of the selected digital content is to be added to a space, such as a shared space 118 or a private space 117. Based on the selected digital content and the selected space, a central system 110 extracts the content and submits it to the AI 140. The central system 110 can be implemented on the client device 120 or one or more computers remote from the client device 120. The AI 140 generates keywords (as in operation 406). The central system 110 receives the keywords from the AI 140 and adds the keywords to the knowledge graph 150 (as in operation 408). The keywords are added to the space (e.g., a private space 117 or a shared space 118) in the vector database 130.

The web browser extension 128 may perform dual-search functions when the client device 120 is used to perform a search. In some implementations, when the client device 120 submits a search query, the browser extension 128 can automatically perform a, e.g., federated, search on the knowledge graph 150 in addition to an external tool 416 (e.g., a search engine) performing its own search on the internet. The search performed by the browser extension 128 can use the same search phrase as that in the search query for the external tool. The browser extension 128 may include the results of the external tool into the selected digital content for inclusion in the space. The browser extension 128 can include metadata related to the search query and automatically tag the search query and the search results with the metadata.

The space can be any appropriate type of space, have any appropriate properties, or both. In some implementations, the space is a private space 117. In some implementations the space is a shared space 118. In either a private space 117 or a shared space 118 access can be limited. In some implementations, the space is a shared space 118 which is shared amongst multiple accounts 124 or multiple client devices 120. A shared space 118 may have limitations imposed on client devices 120 or accounts 124 accessing it. Limitations can include a requirement to authenticate an account 124 or client device 120 before access is granted. In some examples, an account 124 or client device 120 can have different permissions when interacting with a space. For example, a first client device 120-1 may have full access to add, edit, and delete items from a space, but a second client device 120-2 may have only permission to access the space and retrieve files but not edit items in the space. Example authentications include a password, biometric data, voice phrase, and the like. In some implementations, in a space, the stored information may be encrypted to enhance security.

In some implementations, the browser extension 128 extracts digital content from a webpage and sends an API request to the space managed by the central system 110 requesting processing and storage of the digital content. The central system 110 receives the API request from the browser extension 128 and the digital content or an indicator of the digital content. The central system 110 receives the digital content from the browser extension 128, accesses the digital content based on the indicator, or both. The central system 110 processes the digital content by generating keywords, adding the keywords to the knowledge graph, adding the keywords and the digital content to the space in the vector database, or any combination of these. The central system 110 can confirm receipt and processing of the digital content to the browser extension 128, e.g., can provide a confirmation message to the browser extension 128.

The browser extension 128 may select a space from one or more spaces based on a criterion. Example criteria include recency of accessing the space, number of accounts accessing the space in a time period, number of client devices accessing the space in a time period, similarity calculations between keywords of the space and the digital content, metadata of the digital content, and their combinations.

In an example, the API request comprises a JSON web token (JWT) exchanged between the browser extension 128 and the central system 110. When a JWT is transmitted and its recipient can authenticate the JWT by confirming that the signature of the JWT is a valid signature. As JWTs are exchanged between the browser extension 128 and the central system 110, either the browser extension 128 or the central system can authenticate the JWT's signature, when such authentication is required.

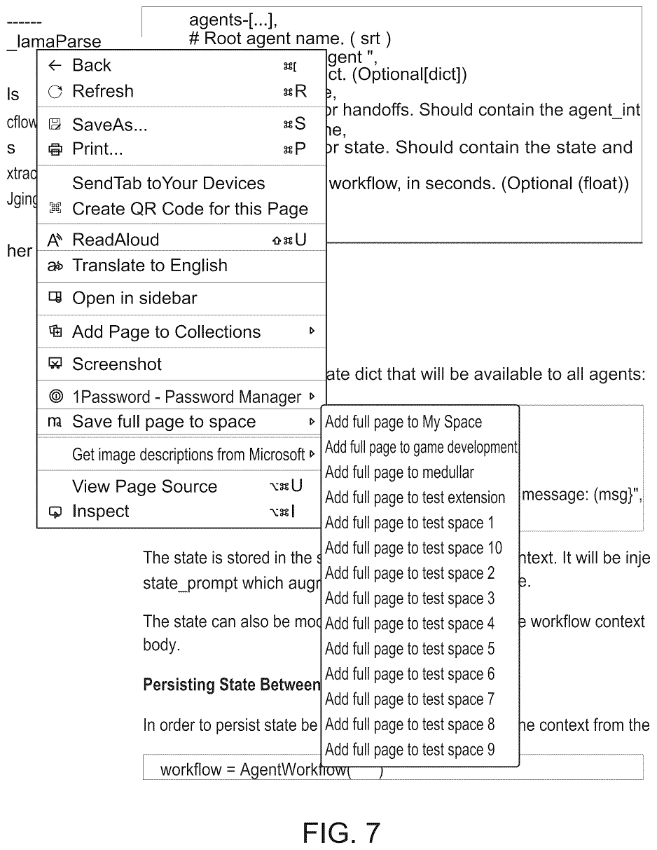

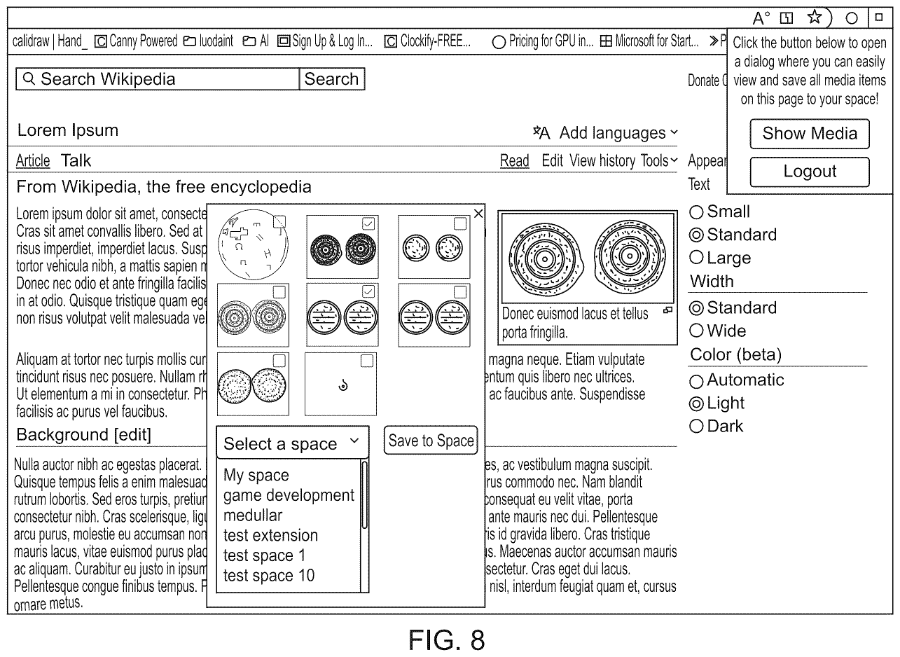

FIGS. 7 and 8 illustrate examples of the browser extension's capabilities. FIG. 7 illustrates an example of the browser extension 128 adding an entire web page to the space. For instance, a user interface can include an “Save full page to space” option that causes the addition of the entire web page, or a corresponding website, to a selected space.

FIG. 8 illustrates an example of the browser extension 128 adding specific content, e.g., only the selected images, of the web page to the space. The browser extension 128 can add files, text, video, audio, images, or any combination of these to a space (e.g., a private space 117 or a shared space 118). In some implementations, the client device 120 selects the particular space to which the specific content is added from an example pulldown menu. The system and method are not limited to pulldown menus and can use any appropriate type of menus, e.g., audible menus or other types of visual menus.

For situations in which the systems discussed here collect personal information about people, or may make use of personal information, the people may be provided with an opportunity to control whether programs or features collect personal information (e.g., information about a person's activities, a person's preferences, or a person's current location), or to control whether and/or how the system operates. In addition, certain data may be anonymized in one or more ways before it is stored or used, so that personally identifiable information is removed. For example, a person's identity may be anonymized so that no personally identifiable information can be determined for the person, or a person's geographic location may be generalized where location information is obtained (such as to a city, ZIP code, or state level), so that a particular location of a person cannot be determined. Thus, the person may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

An electronic document, which for brevity will simply be referred to as a document, may, but need not, correspond to a file. A document may be stored in a portion of a file that holds other documents, in a single file dedicated to the document in question, or in multiple coordinated files.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

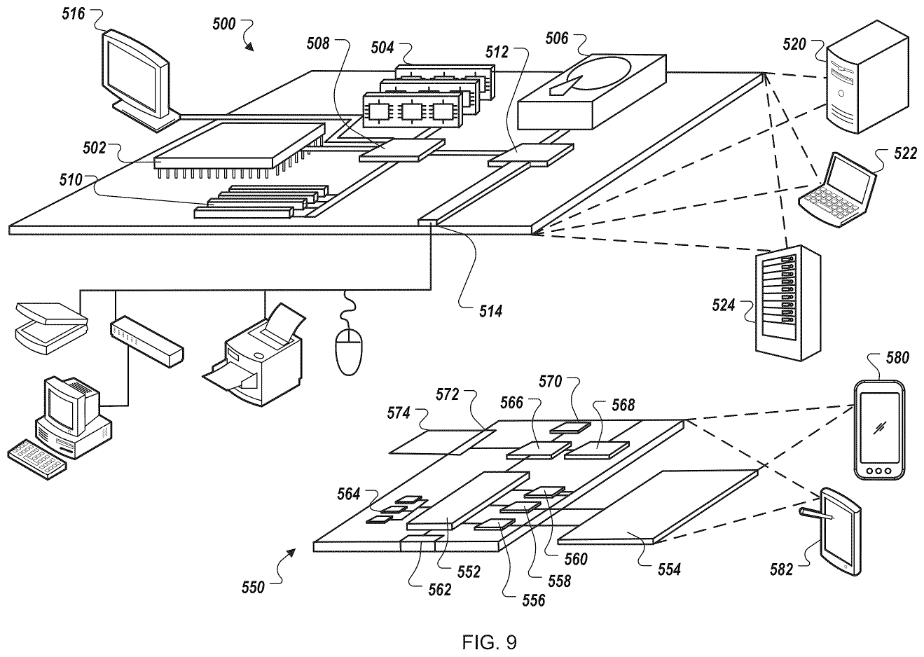

FIG. 9 is a block diagram of computing devices 500, 550 that may be used to implement the systems and methods described in this specification, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550 or may also store applications or other information for device 550. Specifically, expansion memory 574 may include instructions to carry out or supplement the processes described above and may include secure information also. Thus, for example, expansion memory 574 may be provided as a security module for device 550 and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580, e.g., a smartphone. In some instances, the computing device 550 may be implemented as a tablet 582. Other types of the computing device 550 can include an extended reality device, e.g., an augmented reality device or a virtual reality device, a personal digital assistant, or another similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
receiving, for a shared space and from a first client device associated with a first account, a first identifier of a data source;
extracting a key phrase from the data source;
adding, to a knowledge graph for the shared space, the key phrase;
receiving, through the shared space and from a second client device for a second account and that has access to the shared space, a query;
generating, using one or more key phrases from the knowledge graph for the shared space, a response to the query that represents associations between the one or more key phrases in the knowledge graph while not explicitly including at least some of the one or more key phrases used to generate the response; and
transmitting, to the second client device, the response to the query.

2. The method of claim 1, wherein extracting the key phrase uses at least one of a large language model, natural language processing, or retrieval augmented generation.

3. The method of claim 1, further comprising:
after extracting the key phrase from the data source, determining whether an extraction threshold is satisfied for the data source; and
in response to determining that the extraction threshold is satisfied for the data source, deleting any local data for the data source.

4. The method of claim 3, further comprising:
generating an embedding of the key phrase and a second identifier; and
storing the embedding in a vector database.

5. The method of claim 4, wherein storing the embedding in the vector database comprises encrypting the embedding; and
storing the encrypted embedding in the vector database.

6. The method of claim 1, wherein the first identifier comprises metadata of the data source and wherein adding the key phrase to the knowledge graph for the shared space comprises updating the key phrase by appending the metadata to the key phrase and storing the updated key phrase in the knowledge graph of the shared space.

7. The method of claim 1, wherein:
adding the key phrase comprises adding, to the knowledge graph for the shared space, the key phrase and a second identifier of the data source; and
generating the response comprises:
determining, using the second identifier of the data source, a permission for a second account to access the data source; and
generating the response using the permission for the second account to access the data source.

8. The method of claim 7, further comprising:
receiving a request from a third computer for a third account to delete data for a data source; and
deleting, from the knowledge graph, the data using identifiers in the knowledge graph.

9. The method of claim 1, wherein receiving, for the shared space, the first identifier of the data source comprises:
capturing, by a browser extension on the first client device, query data associated with the query and that was provided as input to another system;
determining, by the browser extension, to associate the query data with the data source that has the first identifier; and
in response to determining to associate the query data with the data source that has the first identifier, transmitting, by the browser extension, the first identifier of the data source.

10. The method of claim 1, wherein:
two or more shared spaces comprise the shared space, and
adding the key phrase to the knowledge graph for the shared space comprises:
selecting, by the first client device and from the two or more shared spaces, a shared space; and
adding the key phrase to the knowledge graph of the selected shared space of the one or more shared spaces.

11. The method of claim 10, wherein selecting the shared space from the one or more shared spaces comprises:
ranking each of the two or more shared spaces using a criterion; and
selecting the shared space from the two or more shared spaces using the ranking of the two or more shared spaces.

12. The method of claim 11, wherein ranking each of the two or more shared spaces uses the criterion that comprises at least one of a similarity calculation between keywords of each of the one or more shared spaces and the first identifier, a recency of accessing each of the one or more shared spaces by the first account, or a number of accounts accessing each of the one or more shared spaces.

13. A system comprising one or more computers and one or more storage devices on which are stored instructions that are operable, when executed by the one or more computers, to cause the one or more computers to perform a method comprising:
receiving, for a shared space and from a first client device associated with a first account, a first identifier of a data source;
extracting a key phrase from the data source;
adding, to a knowledge graph for the shared space, the key phrase;
receiving, through the shared space and from a second client device for a second account and that has access to the shared space, a query;
generating, using one or more key phrases from the knowledge graph for the shared space, a response to the query that represents associations between the one or more key phrases in the knowledge graph while not explicitly including at least some of the one or more key phrases used to generate the response; and
transmitting, to the second client device, the response to the query.

14. The system of claim 13, further comprising:
after extracting the key phrase from the data source, determining whether an extraction threshold is satisfied for the data source; and
in response to determining that the extraction threshold is satisfied for the data source, deleting any local data for the data source.

15. The system of claim 14, further comprising:
generating an embedding of the key phrase and a second identifier;
encrypting the embedding; and
storing the embedding in a vector database.

16. The system of claim 13, wherein the first identifier comprises metadata of the data source and wherein adding the key phrase to the knowledge graph for the shared space comprises updating the key phrase by appending the metadata to the key phrase and storing the updated key phrase in the knowledge graph of the shared space.

17. The system of claim 13, wherein:
adding the key phrase comprises adding, to the knowledge graph for the shared space, the key phrase and a second identifier of the data source; and
generating the response comprises:
determining, using the second identifier of the data source, a permission for a second account to access the data source; and
generating the response using the permission for the second account to access the data source.

18. The system of claim 13, wherein receiving, for the shared space, the first identifier of the data source comprises:
capturing, by a browser extension on the first client device, query data associated with the query and that was provided as input to another system;
determining, by the browser extension, to associate the query data with the data source that has the first identifier; and
in response to determining to associate the query data with the data source that has the first identifier, transmitting, by the browser extension, the first identifier of the data source.

19. The system of claim 13, wherein:
two or more shared spaces comprise the shared space, and
adding the key phrase to the knowledge graph for the shared space comprises:
selecting, by the first client device and from the two or more shared spaces, a shared space; and
adding the key phrase to the knowledge graph of the selected shared space of the one or more shared spaces.

20. One or more computer storage media encoded with instructions that, when executed by one or more computers, cause the one or more computers to perform a method comprising:
receiving, for a shared space and from a first client device associated with a first account, a first identifier of a data source;
extracting a key phrase from the data source;
adding, to a knowledge graph for the shared space, the key phrase;
receiving, through the shared space and from a second client device for a second account and that has access to the shared space, a query;
generating, using one or more key phrases from the knowledge graph for the shared space, a response to the query that represents associations between the one or more key phrases in the knowledge graph while not explicitly including at least some of the one or more key phrases used to generate the response; and
transmitting, to the second client device, the response to the query.
